(19) United States
(12) Patent Application Publication
(10) Pub. No.: US 2005/0278278 A1
(43) Pub. Date: Dec. 15, 2005

(54) Class loading jar operation optimizations

(76) Inventors: Petio G. Petev, Sofia (BG); Nikolai S. Dimitrov, Sofia (BG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/856,136

(22) Filed: May 28, 2004

(51) Int. Cl. G06F 7/00

(52) U.S. Cl. 707/1

(57) ABSTRACT

Embodiments include a system for releasing unused files. The files may be held open initially by a virtual machine, class loader, application or similar program. Embodiments register the access times to files with a timeout manager program. After a predetermined time period where no access has been made to a file, the file may be closed. This allows an update module to replace or modify files that have been closed while keeping open files that are frequently used to minimize the processing time for accessing frequently used files.

### BACKGROUND

1. Field of the Invention

The embodiments of the invention relate to file handling. Specifically, embodiments of the invention relate to optimizations of file handling to close unneeded files and keep frequently accessed files open to facilitate file update and removal.

2. Background

A cluster system is utilized to provide a set of services and resources to a set of client computers. The cluster system includes a collection of server nodes and other components that are arranged to cooperatively perform computer-implemented tasks, such as providing client computers with access to the set of services and resources. A cluster system may be used in an enterprise software environment to handle a number of tasks in parallel. A cluster system is scalable and has the flexibility to enable additional cluster elements to be incorporated within or added to the existing cluster elements.

Traditional client-server systems provided by a cluster system employ a two-tiered architecture. Applications executed on the client side of the two-tiered architecture are comprised of a monolithic set of program code including a graphical user interface component, presentation logic, business logic and a network interface that enables the client to communicate over a network with one or more servers in a clustered system that provide access to a set of services and resources.

The “business logic” component of the application represents the core of the application, i.e., the rules governing the underlying business process (or other functionality) provided by the application. The “presentation logic” describes the specific manner in which the results of the business logic are formatted for display on the user interface.

The limitations of the two-tiered architecture become apparent when employed within a large enterprise system. For example, installing and maintaining up-to-date client-side applications on a large number of different clients is a difficult task, even with the aid of automated administration tools. Moreover, a tight coupling of business logic, presentation logic and the user interface logic makes the client-side code very brittle. Changing the client-side user interface of such applications is extremely difficult without breaking the business logic, and vice versa. This problem is aggravated by the fact that, in a dynamic enterprise environment, the business logic may be changed frequently in response to changing business rules. Accordingly, the two-tiered architecture is an inefficient solution for enterprise systems.

In response to limitations associated with the two-tiered client-server architecture, a multi-tiered architecture has been developed. In the multi-tiered system, the presentation logic, business logic and set of services and resources are logically separated from the user interface of the application. These layers are moved off of the client to one or more dedicated servers on the network. For example, the presentation logic, the business logic, and the database may each be maintained on separate servers. In fact, depending on the size of the enterprise, each individual logical layer may be spread across multiple dedicated servers.

This division of logical components provides a more flexible and scalable architecture compared to that provided by the two-tier model. For example, the separation ensures that all clients share a single implementation of business logic. If business rules change, changing the current implementation of business logic to a new version may not require updating any client-side program code. In addition, presentation logic may be provided which generates code for a variety of different user interfaces, which may be standard browsers such as Internet Explorer® or Netscape Navigator®.

A multi-tiered architecture may be implemented using a variety of different application technologies at each of the layers of the multi-tier architecture, including those based on the Java 2 Enterprise Edition Specification created by Sun Microsystems, Santa Clara, Calif. (“J2EE”), the Microsoft .NET Framework created by Microsoft Corporation of Redmond, Wash. (“.Net”) and/or the Advanced Business Application Programming (“ABAP”) standard developed by SAP AG. For example, in a J2EE environment, the business layer, which handles the core business logic of the application, is comprised of Enterprise Java Bean (“EJB”) components with support for EJB containers. Within a J2EE environment, the presentation layer is responsible for generating servlets and Java Server Pages (“JSP”) interpretable by different types of browsers at the user interface layer.

Many of these enterprise platforms provide inefficient file handling schemes or file handling schemes that prevent an update of application files while the applications are running. For example, in the java virtual machine platform, the class loading system opens java archive files upon their first usage. The java archive files are not closed until a garbage collecting procedure for the class loader is executed. This prevents any other application from modifing these java archive files. As a result, updates of files in these enterprise platforms requires a system restart and the generation of a set of scripts to complete an installation or update of system files during the restart.

### SUMMARY

Embodiments include a system for releasing unused files. The files may be held open initially by a virtual machine, class loader, application or similar program. Embodiments register the access times to files with a timeout manager program. After a predetermined time period where no access is made to a file, the file may be released. This allows an update module to replace or modify files that have been released while keeping open files that are frequently used to minimize the processing time for accessing frequently used files.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a block diagram of one embodiment of a file handling system.

FIG. 2 is a flowchart of one embodiment of a process for handling files.

FIG. 3 is a diagram of one embodiment of a computer system running the file handling system.

FIG. 4 is a diagram of one embodiment of a cluster system running the file handling system.

### DETAILED DESCRIPTION

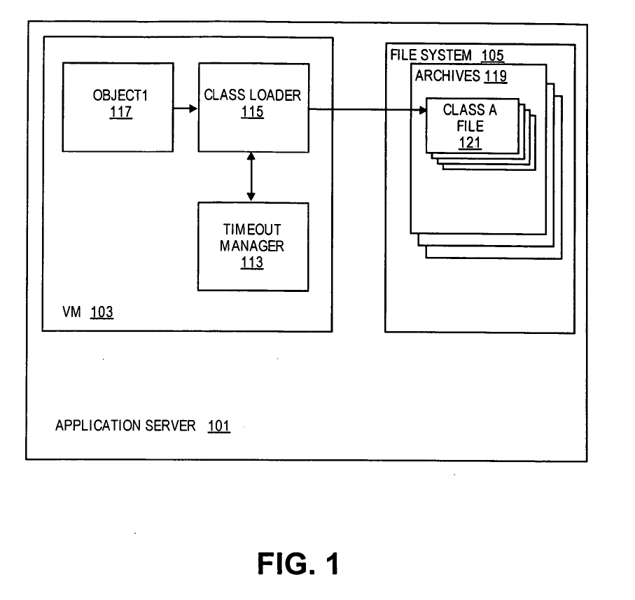

FIG. 1 is one embodiment of a file handling system. In one embodiment, the file handling system operates on a local machine to release unused or infrequently used files of applications and services provided by the local machine. In one embodiment, the local machine is an application server 101. Application server 101 may provide access to services and resources for a set of clients. Clients may be remote computers, a local application, and similar programs and systems that may be local to application server 101 or remote from application server 101. In one embodiment, the services and resources provided by application server 101 may be applications and services related to enterprise software and resources.

In one embodiment, the local machine may have a file system 105. File system 105 may be used to organize and store files related to the applications and services provided by application server 101. In one embodiment, files stored by files system 105 may include archive files 119. An archive file may be a file that may contain multiple files in a compressed or encrypted format. In one embodiment, an archive file may be a java archive file. A java archive file may be used to store code in class files to be used to instantiated objects in a java virtual machine 103. In another embodiment, other types of archive files may be supported by the file handling system including zip files, software deployment archives, and similar archive files. In one embodiment, archive file 119 may store other types of files including binary files, data, text files and similar file types. In one embodiment, file system 105 may store any type of file including archive files, binary files, text files, database files and similar file formats.

In one embodiment, the local machine may execute applications and services using a virtual machine 103 environment. Virtual machine 103 may be a java virtual machine such as a java virtual machine based on the Java 2 Enterprise Edition Specification (J2EE) created by Sun Microsystems, Santa Clara, Calif., or similar virtual machine. Virtual machine 103 may support any number of applications and services including a file handling system. Applications, services and similar programs and modules may be executed by the local machine in the form of objects 117 or sets of objects.

In one embodiment, applications and services in the form of objects may be loaded by a loader module or set of loader modules. A loader module may be a class loader 115 or similar loading utility. A loader module or program may be used to retrieve data and instructions from the files. This loader module may open the file to read the data and instructions and then leave the file in an open state during execution of the application. Files in an open state may not be moved, modified or deleted by other applications, utilities or programs. Opening files or archives may involve decompressing a file or archive and performing security checks such as certificate checks or similar security checks. As a result opening files may require significant processing or system time. Applications and services may be loaded from compiled binary files, or code files to be executed or interpreted. In one embodiment, during operation virtual machine 103 may invoke class loader 115 or a set of class loaders to open files and archives 119 to retrieve the code of the applications and services to be executed by the virtual machine. For example, class loader 115 may load a class file from a java archive file during system startup at the request of java virtual machine 103. The archive files may remain open until class loader 115 is garbage collected.

In one embodiment, the loader module such as class loader 115 may register files that have been loaded with a timeout manager 113. Timeout manager 113 may track a set of registered entries and notify a corresponding program when a designated period of time has elapsed. For example, class loader 115 may register a first access to class file A 121 when virtual machine 103 attempts to instantiate object A 117. When a predefined period of time elapses, for example thirty seconds, timeout manager 113 notifies class loader 115 that the predefined period of time has elapsed. Class loader 115 may initiate the release of the file from the registration entry that generated the timeout event from timeout manager. In another embodiment, a program other than the loader 115 may be utilized to release the file. As used herein, the ‘load module’ may include such a release program. In one embodiment, if an additional access occurs to a file, then class loader 115 may register the new access and remove (‘unregister’) the previous access time for the file. ‘Releasing’ a file may involve closing the file, releasing a lock on the file or similar methods of making a file available for access by other programs.

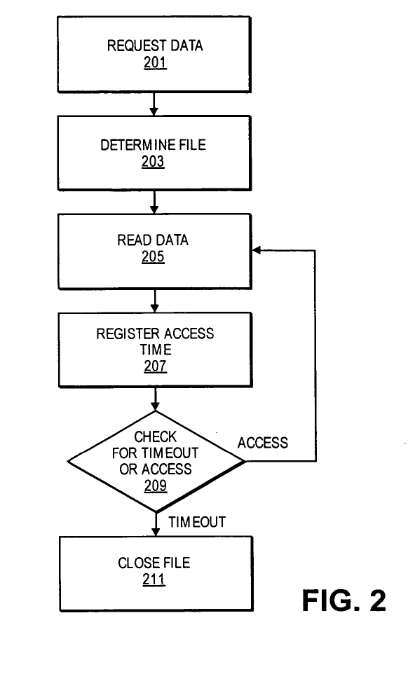

FIG. 2 is a flowchart of one embodiment of a process for handling a file system. In one embodiment, a load module may be invoked, instantiated or similarly executed. The load module may be utilized by a virtual machine or similar application in response to a request to access data in files needed to run, instantiate or similarly execute other applications (block 201). In one embodiment, the requested data or file may be identified by a file name and path name. The path name may be a class path or similar path identification system for determining a location of a file or similar resource. A path or class path may consist of a set of directories where related files may be found or a set of archive files containing a set of related files.

In one embodiment, an invoked loader module may determine if the requested data belongs to a file that the loader module is designated to load (block 203). A set of loader modules such as class loaders or similar loader modules may be structured in a hierarchy or have a set of defined relationships distributing the responsibility for loading executables, class files, and similar programs and data. In one embodiment, the loader module may search through a list or similar data structure of files, path names or similar identifier mechanisms to determine if the loader module is responsible for loading the requested data or file. If the loader module is not responsible for loading a requested file, then the loader module may pass the request on to another loader module or similar program. In one embodiment, a system class loader may be part of the hierarchy.

In one embodiment, a loader module may check the class paths associated with the system class path. If the system class loader is responsible then it may be invoked or utilized to load requested data. If the system class loader is not responsible, then the class loader may check with other class loaders with an immediate relationship to the class loader and then the class loaders own class paths. A load responsibility determination system may be carried out and distributed in any manner used for resolving dependencies between files. For example, a java virtual machine such as the java 2 enterprise edition (J2ee) platform may have a system class loader that may be responsible for loading core platform files and data. The system class loader for J2EE may be responsible for classes from java.*, javax.* and similar packages.

In one embodiment, after load responsibility and the target file or data has been found the loader module initiates a read of the requested data from the target file and returns the data to a requesting application or similar program (block 205). The loader module may directly initiate the access if the file was determined to be its responsibility or may indirectly initiate if another loader module is responsible. For example, a class loader may access a java archive file to retrieve a class file. The class file data is returned to the java virtual machine to instantiate an object based on the class file. A loader module, virtual machine or similar program retains control over the open archive, file or similar structure.

In one embodiment, at approximately the time that a file is first accessed or an access completes, a loader module may register the access with a timeout manager (block 207). Registering an access may include saving a time of an access and an identifier for the file or data that was accessed. A timeout manager may track registered access times and generate a notification or similar response when a defined time period elapses after the registration of the access time. The timeout manager may queue registered access times and periodically check a current time against the registered access times. A registration of an access time may include a parameter to set the time of delay for the notification to occur. In one embodiment, the delay and access time for each entry may be used to order the registered entries according to the chronological expiration of the delay times associated with each registration entry. A timeout manager object or similar program may be generated for each machine, application server, loader module, cluster or similar program or structure. The timeout manager may be distributed or shared across multiple systems.

In one embodiment, the timeout manager may continually or periodically check for the expiration of registered access time delays. Also, registration entries may be updated or replaced when an additional access occurs for a file (block 209). If a file is accessed again, a read of the requested data occurs (block 205). The access of a file may result in a resetting of a delay and the update of the access time for an entry, a deletion of a registration entry and the creation of a new registration entry or similar updating of the delay tracking mechanism (block 207). If the delay expires, a timeout event my be generated and the loader module or associated application that holds the registered file open may be notified of the expiration of the delay period. The loader module or application may then release or close the file (block 211). A delay period may be set to a length calculated to indicate that a file is infrequently used. The calculation of the delay length may be based on the time required to reopen the file if an access occurs. Releasing a file may allow the file to be replaced or modified if a computer system is updated without requiring a restart of the computer system. Releasing a file after a delay instead of releasing a file during garbage collection may provide better stability because the state of the file, whether open or closed, is more easily discernable. Releasing a file after a timeout period instead of immediately after the completion of an access improves system efficiency because frequently accessed files will remain open and do not have to be reopened.

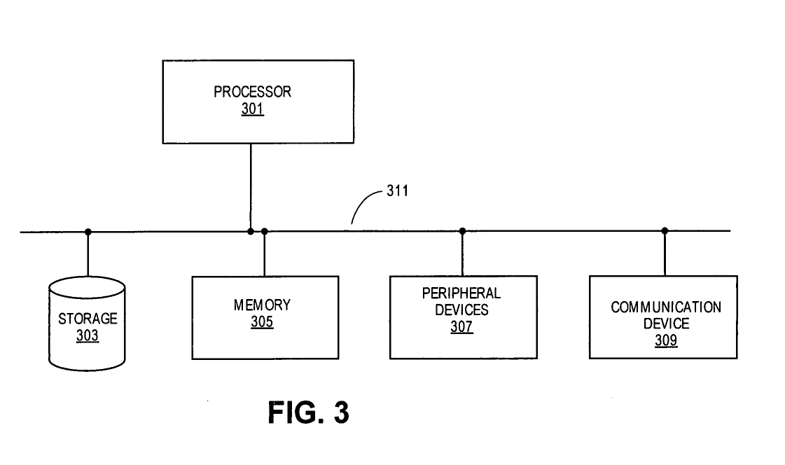

FIG. 3 is a block diagram of an exemplary computer system for executing the file handling system. In one embodiment, the computer system may include a processor 301 or set of processors to execute the file handling system, virtual machine, applications, services and similar programs. The processor may be a general purpose processor, application specific integrated circuit (ASIC) or similar processor. Processor 301 may be in communication via a bus 311 or similar communication medium with a memory device 305. Memory device 305 may be a system memory device or set of devices such as double data rate (DDR) memory modules, synchronized dynamic random access memory (SDRAM) memory modules, flash memory modules, or similar memory devices. Memory device 305 may be utilized by processor 301 as a working memory to execute the virtual machine, applications, the file handling system and similar programs.

In one embodiment, the computer system may include a storage device 303. Storage device 303 may be a magnetic disk, optical storage medium, flash memory, or similar storage device. Storage device 303 may be utilized to store files. Storage device 303 may organize files in a file system. Stored files may include program files, file handling system files, temporary files, index files and similar files and data structures. The computer system may also include a set of peripheral devices 307. Peripheral devices 307 may include input devices, sound system devices, graphics devices, display devices, auxiliary storage devices, or similar devices or systems utilized with a computer system.

In one embodiment, the computer system may include a communication device 309. Communication device 309 may be a networking device to allow the computer system and applications, services and similar programs to communicate with other computers, applications, services and similar programs. In one embodiment, communication device 309 may be utilized to communicate with a remote database and retrieve or receive files from the database.

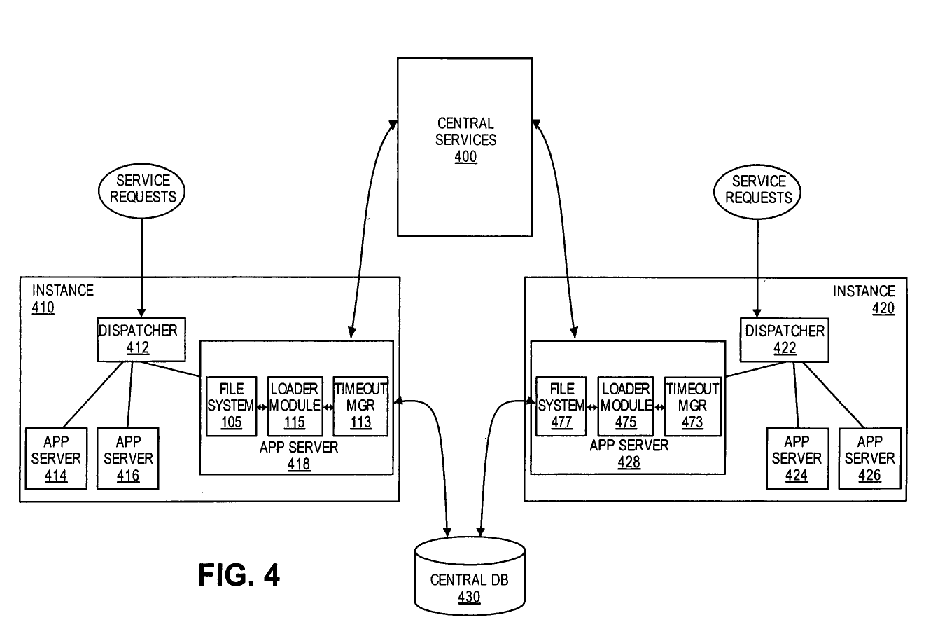

FIG. 4 is one embodiment of a cluster system that includes a file handling system. In one embodiment, the system architecture may include a central services instance 400 and a plurality of application server instances 410, 420. In one embodiment, the application servers are organized into groups referred to as “instances.” Each instance includes a group of redundant application servers and a dispatcher for distributing service requests to each of the application servers. A group of instances may be organized as a “cluster.” The application server instances, 410 and 420, may each include a group of application servers 414, 416, 418 and 424, 426, 428, respectively, and a dispatcher, 412, 422, respectively.

Central services instance 400 may include services shared amongst instances 410, 420 and their constituent parts, as well as other cluster resources such as database 430. These shared services may include a locking service and a messaging service and similar services. In one embodiment, a timeout service may be provided by central service instance 400. The combination of the application instances 410, 420 and the central services instance 400 may be the primary constituents of the cluster system. Although the following description will focus primarily on instance 410 for the purpose of explanation, the same principles and concepts may apply to other instances such as instance 420.

In one embodiment, the application servers 414, 416, 418 within instance 410 may provide business and/or presentation logic for the network applications supported by the cluster system. Each of application servers 414, 416 and 418 within a particular instance 410 may be configured with a redundant set of application logic and associated data. In one embodiment, dispatcher 410 distributes service requests from clients to one or more of application servers 414, 416 and 418 based on the load on each of the servers.

In one embodiment, application servers 414, 416 and 418 may be Java 2 Enterprise Edition (“J2EE”) application servers which support Enterprise Java Bean (“EJB”) components and EJB containers (at the business layer) and Servlets and Java Server Pages (“JSP”) (at the presentation layer). In another embodiment, the cluster system, applications servers and file handling system may be implemented in the context of various other software platforms including, by way of example, Microsoft NET platforms and/or the Advanced Business Application Programming (“ABAP”) platforms developed by SAP AG.

In one embodiment, each application server may include a loader module 115, 475. Loader modules 115, 475 may be utilized by applications, virtual machines and similar programs to access files needed by the applications, virtual machines and similar programs. Loader modules 115, 475 may manage the retrieval of data from files and archives stored in the file systems 105, 477 of each application server. Loader modules 115, 475 may register recent access times of files with a timeout manager 113, 473. Each application server may have its own timeout manager 113, 473, or the timeout manager may be a part of central services 400 and accessible by multiple applications servers and instances. In one embodiment, loader modules 115, 475 may manage loading of remote files and data. For example, loader modules 115, 475 may initiate loads of files and data from central database 430.

In one embodiment, the file handling system may be implemented in software and stored or transmitted in a machine-readable medium. As used herein, a machine-readable medium is a medium that can store or transmit data such as a fixed disk, physical disk, optical disk, CDROM, DVD, floppy disk, magnetic disk, wireless device, infrared device, and similar storage and transmission technologies.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. An apparatus comprising:
a loader module to initiate an access to a file and to automatically release the file after a defined time elapses from the time of access to the file; and
a timeout manager in communication with the loader module to track a time of access to the file.

2. The apparatus of claim 1, wherein the timeout manager comprises:
a queue to file entries chronologically to determine delay expiration.

3. The apparatus of claim 1, wherein the loader module comprises:
a release program to automatically release the file.

4. The apparatus of claim 1, wherein the loader module comprises:
a class loader in a java virtual machine environment.

5. The apparatus of claim 1, further comprising:
a virtual machine to invoke the loader module and to receive data accessed from the file.

6. A method comprising:
opening a file;
accessing data in the file;
storing a time of a most recent access to the file; and
releasing the file automatically if no access has occurred within a defined time period.

7. The method of claim 6, wherein opening a file comprises:
opening a java archive file containing the file.

8. The method of claim 6, further comprising:
registering the time of the most recent access with a timeout service.

9. The method of claim 6, further comprising:
invoking a class loader to open a file.

10. The method of claim 6, further comprising:
resetting the time of most recent access time to the file when an access to the file occurs.

11. A system comprising:
a processor executing an application;
a storage device in communication with the processor containing a file opened by the application; and
a file handling module to automatically release the file after a predetermined time period from an access by the application.

12. The system of claim 11, further comprising:
a timeout manager to track a last access time for the file.

13. The system of claim 11, wherein the application comprises:
a java virtual machine.

14. The system of claim 11, further comprising:
a java archive file containing the file.

15. The system of claim 11, wherein the file handling module comprises:
a class loader module.

16. An apparatus comprising:
means for opening a file;
means for accessing data in the file;
means for storing a time of a most recent access to the file; and
means for automatically closing the file after a defined time period.

17. The apparatus of claim 16, further comprising:
means for storing the file in a java archive file.

18. The method of claim 16, further comprising:
means for registering the most recent access time with a timeout manager.

19. The method of claim 16, further comprising:
means for invoking a class loader to open a file.

20. The method of claim 1, further comprising:
means for resetting a most recent access time after an access of the file.

21. A machine readable medium having a set of instruction stored therein which when executed cause a machine to perform a set of operations comprising:
opening a file;
accessing data in the file;
storing a time of a most recent access to the file; and
closing the file automatically after a defined time period.

22. The machine readable medium of claim 21, having further instructions stored therein which when executed cause a machine to perform a set of operations further comprising:
opening a java archive file containing the file.

23. The machine readable medium of claim 21, having further instructions stored therein which when executed cause a machine to perform a set of operations further comprising:
registering the most recent access time with a timeout manager.

24. The machine readable medium of claim 21, having further instructions stored therein which when executed cause a machine to perform a set of operations further comprising:
invoking a class loader to open a file.

25. The machine readable medium of claim 21, having further instructions stored therein which when executed cause a machine to perform a set of operations further comprising:
resetting the most recent access time in response to an access of the file.
